(19) United States
(12) Patent Application Publication
(10) Pub. No.: US 2009/0320016 A1
(43) Pub. Date: Dec. 24, 2009

(54) IMAGE PROCESSING APPARATUS, CONTROL METHOD THEREFOR, STORAGE MEDIUM, AND DISTRIBUTION SERVER

(75) Inventors: Tamotsu Takatani, Yokohama-shi (JP); Yoko Murase, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/472,109

(22) Filed: May 26, 2009

(30) Foreign Application Priority Data
Jun. 24, 2008 (JP) 2008-164698

(51) Int. Cl. G06F 9/44; G06F 9/445

(52) U.S. Cl. 717/171; 717/178

(57) ABSTRACT

An image processing apparatus in an arrangement where image processing apparatuses are connected to the same network, which is capable of upgrading a version of a common function module of the image processing apparatus while maintaining the consistency between the image processing apparatuses. An MFP connected via the network to a distribution server inquires the server about whether there is a version upgrade program for a function module of a type corresponding to the MFP. If so, the MFP acquires integrated version information on the version upgrade program from the server, updates version upgrade information on the function module based on the acquired information, acquires version upgrade information on function modules of MFPs of other types, and upgrades the version of the function module based on the acquired version upgrade information and the updated version upgrade information.

### BACKGROUND OF THE INVENTION

1. Field of the Invention

The present invention relates to an image processing apparatus having a plurality of function modules, a control method for the image processing apparatus, a storage medium storing a program for executing the control method, and a distribution server that distributes a program for the image processing apparatus.

2. Description of the Related Art

In recent years, multi-function peripherals or MFPs (image processing apparatuses, more generally, information processing apparatuses) having functions of a printer, scanner, facsimile, etc. have widely been employed, each MFP including a plurality of function modules to realize multiple functions, and the function modules are conventionally manually version-upgraded on a per MFP basis.

With the spread use of MFPs, a problem of increasing the labor and time required for manual version upgrade of function modules has become noticeable. An attempt has been made to configure each MFP to be able to download version upgrade programs for its function modules from a server and automatically update the versions of the function modules.

If function modules of some MFP are automatically version-upgraded, however, there is a fear that the consistency between the function modules of the MFP cannot be maintained, resulting in an exchange failure between the function modules, which causes an abnormality in operation of the MFP. In a case for example that an image reading function module is version-upgraded, with the version of an image-information receiving function module not upgraded, there is a fear that a failure takes place in image information exchange between these function modules, if a format for image exchange therebetween is changed due to the version upgrade of the image reading function module.

To prevent such a failure, there has been proposed a version upgrade apparatus able to upgrade the versions of function modules of an MFP, while maintaining the consistency between the function modules of the MFP (see, for example, Japanese Laid-open Patent Publication No. 2001-337817).

In a case for example that a number of MFPs are placed on the same floor, there is a demand that the same image output should be obtained between the MFPs. To meet this demand, the consistency must be maintained between common function modules of different types of MFPs, such as a color function module and an image processing function module.

Since different types of MFPs have been developed independently, version upgrade programs for common function modules of these MFPs are usually released at different times. If the version upgrade programs for common function modules are released at different times in a circumstance that each of different types of MFPs automatically upgrades the versions of function modules, a problem is posed that the consistency cannot be maintained between the common function modules of the MFPs.

With the conventional version upgrade apparatus described above, the consistency between function modules in each one of MFPs can be maintained, but the consistency cannot be maintained between common function modules of different types of MFPs.

Common function modules of different types of MFPs can be version-upgraded in the same timing to maintain the consistency between versions of the common function modules However, if a job process or a version upgrade of other function module is being performed in some MFP, the version upgrade of the common function module of that MFP must be made later, which poses a problem. Another problem is that the version upgrade of a common function module of some MFP cannot normally be completed in some cases.

### SUMMARY OF THE INVENTION

The present invention provides an image processing apparatus capable of upgrading a version of a function module common to image processing apparatuses on the same network, while maintaining the consistency between the image processing apparatuses, and provides a control method for the image processing apparatus, a storage medium storing a program for executing the control method, and a distribution server that distributes such a program.

According to a first aspect of this invention, there is provided an image processing apparatus connected via a network to a distribution server for at least distributing a program for the image processing apparatus, which comprises a reception unit adapted, in a case where a version upgrade program for a function module of a type corresponding to the image processing apparatus is present in the distribution server, to receive integrated version information on the version upgrade program from the distribution server, the integrated version information being used for unifying functions of function modules of image processing apparatuses of different types on the network, an update unit adapted to update, based on the integrated version information received by the reception unit, version upgrade information indicating a version to which the function module of the image processing apparatus can be upgraded, an acquisition unit adapted to acquire version upgrade information on the function module of at least one other image processing apparatus of different type on the network, and a determination unit adapted to determine, based on the version upgrade information updated by the update unit and the version upgrade information acquired by the acquisition unit, whether the function module of the image forming apparatus should be version-upgraded.

According to a second aspect of this invention, there is provided a distribution server connected to image processing apparatuses via a network and adapted to distribute programs for the image processing apparatuses, which comprises a grouping unit adapted to group the image processing apparatuses on the network on a per function-module basis, a hold unit adapted to hold version upgrade programs for function modules of the image processing apparatuses, a determination unit adapted to determine whether or not each of the version upgrade programs should be released, on a per image processing apparatus group basis, based on integrated version information on the version upgrade programs used for unifying functions of function modules of image processing apparatuses of different types, and a release unit adapted to release, to the network, at least one of the version update programs which is determined by the determination unit to be released.

According to a third aspect of this invention, there is provided an image processing apparatus connected via a network to a distribution server for at least distributing a program for the image processing apparatus and a license server for at least managing a license for the program, which comprises a download unit adapted to download the program from the distribution server, a first determination unit adapted to determine whether or not the downloaded program should be installed into the image processing apparatus based on a license status of the program in an apparatus that operates in conjunction with the image processing apparatus, an installation unit adapted to install the downloaded program into the image processing apparatus in a case where the first determination unit determines that the downloaded program should be installed thereinto, a second determination unit adapted to determine, based on a license status of the installed program in the image forming apparatus, whether or not the installed program should be made executable, and a state alteration unit adapted to make the installed program executable in a case where the second determination unit determines that the installed program should be made executable.

According to a fourth aspect of this invention, there is provided a control method for an image processing apparatus connected via a network to a distribution server for at least distributing a program for the image processing apparatus, which comprises a reception step of receiving integrated version information on a version upgrade program from the distribution server in a case where the version upgrade program for a function module of a type corresponding to the image processing apparatus is present in the distribution server, the integrated version information being used for unifying functions of function modules of image processing apparatuses of different types on the network, an update step of updating, based on the integrated version information received in the reception step, version upgrade information indicating a version to which the function module of the image processing apparatus can be upgraded, an acquisition step of acquiring version upgrade information on the function module of at least one other image processing apparatus of different type on the network, and a determination step of determining, based on the version upgrade information updated in the update step and the version upgrade information acquired in the acquisition step, whether the function module of the image forming apparatus should be version-upgraded.

According to a fifth aspect of this invention, there is provided a computer-readable storage medium storing a program for causing a computer to execute the control method according to the fourth aspect of this invention.

In an arrangement where a number of image processing apparatuses are connected to the same network, this invention makes it possible to upgrade the versions of common function modules of image processing apparatuses, while maintaining the consistency between the image processing apparatuses.

Further features of the present invention will become apparent from the following description of exemplary embodiments with reference to the attached drawings.

### BRIEF DESCRIPTION OF THE DRAWINGS

FIG. 1 is a block diagram showing the construction of an information processing system including image processing apparatuses according to a first embodiment of this invention;

FIG. 2 is a view for explaining a case where an inconvenience is caused in the information processing system in FIG. 1 due to a version difference between common function modules of MFPs;

FIG. 3 is a view showing an example of a version integration setting screen displayed by an input/output unit of the MFP in FIG. 1;

FIG. 4 is a flowchart showing aversion integration setting process in the first embodiment;

FIG. 5 is a flowchart showing a version upgrade process in the first embodiment;

FIG. 6 is a view for explaining a case where an inconvenience is caused in the information processing system of FIG. 1 when an A-type MFP will never be version-upgraded;

FIG. 7 is a flowchart showing a version upgrade process according to a second embodiment of this invention;

FIG. 8 is a view showing an example version integration setting cancellation screen displayed by an input/output unit of the MFP in the version upgrade process in FIG. 7;

FIG. 9 is a view schematically showing the construction of an information processing system according to a third embodiment of this invention;

FIG. 10 is a view showing an example grouping setting screen displayed by an input/output unit of a distribution server in the information processing system in FIG. 9;

FIG. 11 is a flowchart showing a version upgrade program release process in the third embodiment;

FIG. 12 is a flowchart showing a version upgrade process according to a fourth embodiment of this invention;

FIG. 13 is a view showing an example UI screen displayed by an input/output unit of the MFP in FIG. 9;

FIG. 14 is a block diagram showing the construction of an information processing system including an image processing apparatus according to a fifth embodiment of this invention;

FIG. 15 is a view for explaining a case where a function of a server MFP is not executable in the information processing system of FIG. 14 and a user misunderstands that the function is executable;

FIG. 16 is a flowchart showing a client-side version upgrade process in the fifth embodiment;

FIG. 17 is a flowchart showing a server-side version upgrade process in the fifth embodiment;

FIG. 18 is a flowchart showing another client-side version upgrade process in the fifth embodiment.

### DETAILED DESCRIPTION OF THE PREFERRED EMBODIMENTS

The present invention will now be described in detail below with reference to the drawings showing preferred embodiments thereof.

The following is a description of an information processing system that includes image processing apparatuses according to a first embodiment of this invention.

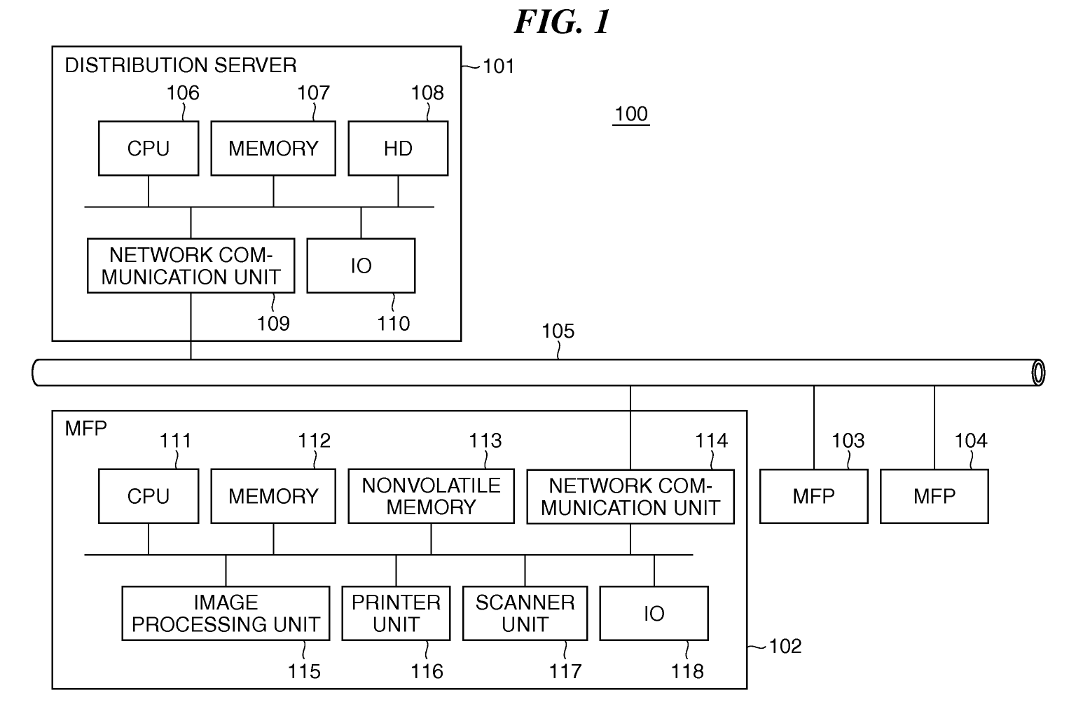

FIG. 1 shows in block diagram the construction of the information processing system including image processing apparatuses of this embodiment.

As shown in FIG. 1, the information processing system 100 includes a distribution server 101 and multi-function peripherals or MFPs 102 to 104 (image processing apparatuses) different in type from one another. The server 101 and the MFPs 102 to 104 are connected via a network 105 with one another. The distribution server 101 stores programs for function modules of the MFPs 102 to 104.

The distribution server 101 includes a CPU 106, a memory 107, a hard disk (HD) 108, a network communication unit 109, and an input/output unit (IO) 110.

The CPU 106 executes procedures for the distribution server 101. The memory 107 stores the procedures for the distribution server 101 and version upgrade information on function module programs for the MFPs 102 to 104 stored in the HD 108. The version upgrade information indicate versions to which respective ones of the function modules can be upgraded. The details of the version upgrade information will be described later. The HD 108 stores programs for the function modules of the MFPs 102 to 104. The IO 110 includes input devices such as a keyboard and a mouse and output devices such as a monitor.

The MFP 102 includes a CPU 111, a memory 112, a nonvolatile memory 113, a network communication unit 114, an image processing unit 115, a printer unit 116, a scanner unit 117, and an input/output unit (IO) 118.

The CPU 111 executes procedures for the MFP 102. The memory 112 stores the procedures for the MFP 102 and information representing function modules of the MFP 102. The nonvolatile memory 113 stores programs for the function modules of the MFP 102. The image processing unit 115 converts read image information into a format in which the MFP 102 is able to output the image information. The printer unit 116 outputs an image. The scanner unit 117 reads an image. The IO 118 for accepting user's input is comprised of, e.g., a touch panel type user interface (UI).

The network 105 is implemented by the Internet, a telephone line network, an ISDN line network, a dedicated line, an optical communication line network, a wireless communication network, or the like.

In the information processing system 100, the distribution server 101 is, e.g., a printer server that manages a number of MFPs placed at a location. The distribution server 101 is connected to a MFP manufacturer's server (not shown). When a version upgrade program for any of the MFPs managed by the distribution server 101 is released, the distribution server 101 downloads the version upgrade program from the manufacturer's server, and temporarily stores the downloaded version upgrade program into the HD 108, thereby managing programs for the function modules of the MFPs 102 to 104.

Usually, the MFPs 102 to 104 monitor the distribution server 101 at regular intervals. When a version upgrade program for any of the function modules of the MFPs is released, the corresponding MFP downloads the version upgrade program from the distribution server 101 and upgrades the version of the corresponding function module.

In the arrangement where the MFPs 102 to 104 of different types are connected via the same network 105 to the distribution server 101, the versions of common function modules of the MFPs 102 to 104 are updated in different timings, which causes an inconvenience in some cases.

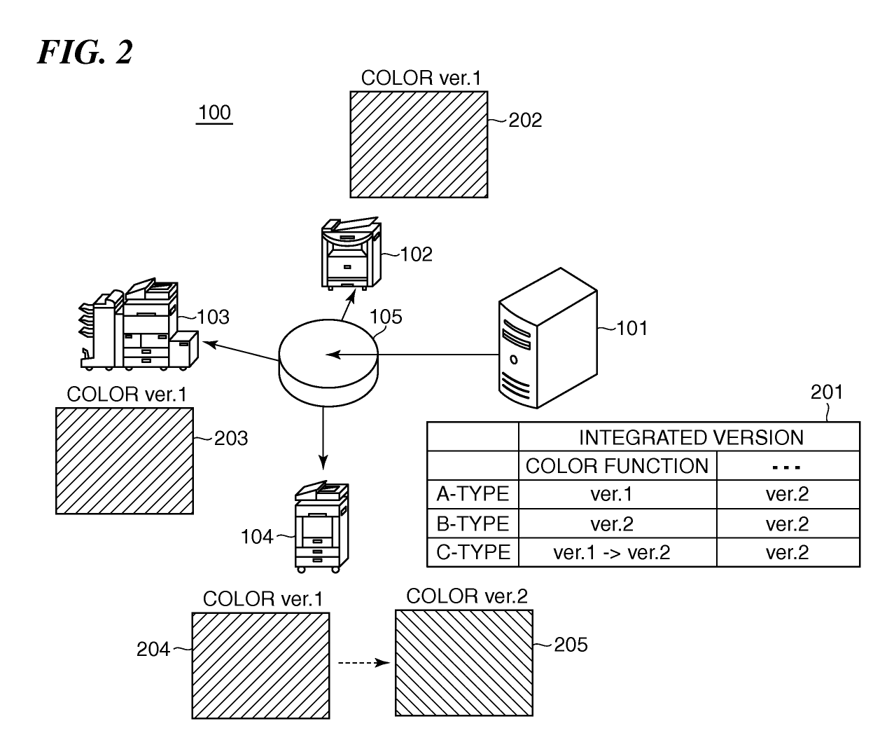

FIG. 2 illustrates a case where an inconvenience is caused in the information processing system 100 due to a version difference between common function modules of the MFPs 102 to 104.

As shown in FIG. 2, the distribution server 101 and the MFP 102 to 104 of A, B and C types respectively are connected to one another via the network 105.

Reference numeral 201 denotes version information stored in the memory 107 of the distribution server 101. These version information 201 can be distributed to the MFPs 102 to 104 and represent versions of function module programs able to be distributed to the MFPs 102 to 104. The version information 201 is comprised of pieces of version information given on a per function-module basis, but may be comprised of integrated version information given on a per function-module-group basis. In general, MFPs of different types are different in image output mechanism and color output control method. Thus, a color standard is defined to obtain the same chromaticness between MFPs of different types, and each MFP includes a color function module that creates and outputs colors of an image based on the color standard. In this embodiment, an integrated version program to equalize the chromaticness between the MFPs 102 to 104 is provided for each color function module (common function module) of the MFPs 102 to 104. Integrated version programs are provided also for common function modules other than the color function module on a per function-module basis. The integrated version is a version of a function module common to different types of MFPs, and is different from a version which is incremented at each usual upgrade. Specifically, the version of a function module is updated each time a bug therein is fixed, whereas the integrated version is not updated until some influence appears on an operation common to different types of MFPs.

Reference numeral 202 denotes an example output image obtained when the integrated version of the color function module of the A-type MFP 102 is a first version (ver. 1), and 203 denotes an example output image obtained when the integrated version of the color function module of the B-type MFP 103 is a first version (ver. 1). Reference numerals 204, 205 denote example output images respectively obtained when the integrated version of the color function module of the C-type MFP 104 is a first version (ver. 1) and a second version (ver. 2).

It is assumed here that a version upgrade program to update the integrated version of the color function module of the C-type MFP 104 to the second version (ver. 2) has been released and held by the distribution server 101. When the C-type MFP 104 recognizes that the version upgrade program for its color function module has been released, the MFP 104 downloads the version upgrade program from the distribution server 101 and upgrades the version of its color function module. As a result, among the A-type MFP 102, B-type MFP 103 and C-type MFP 104 connected to the same network 105, only the color function module of the C-type MFP 104 is version-upgraded, and as shown in FIG. 2, the C-type MFP 104 undesirably outputs an image which is different in chromaticness from images output from the other MFPs.

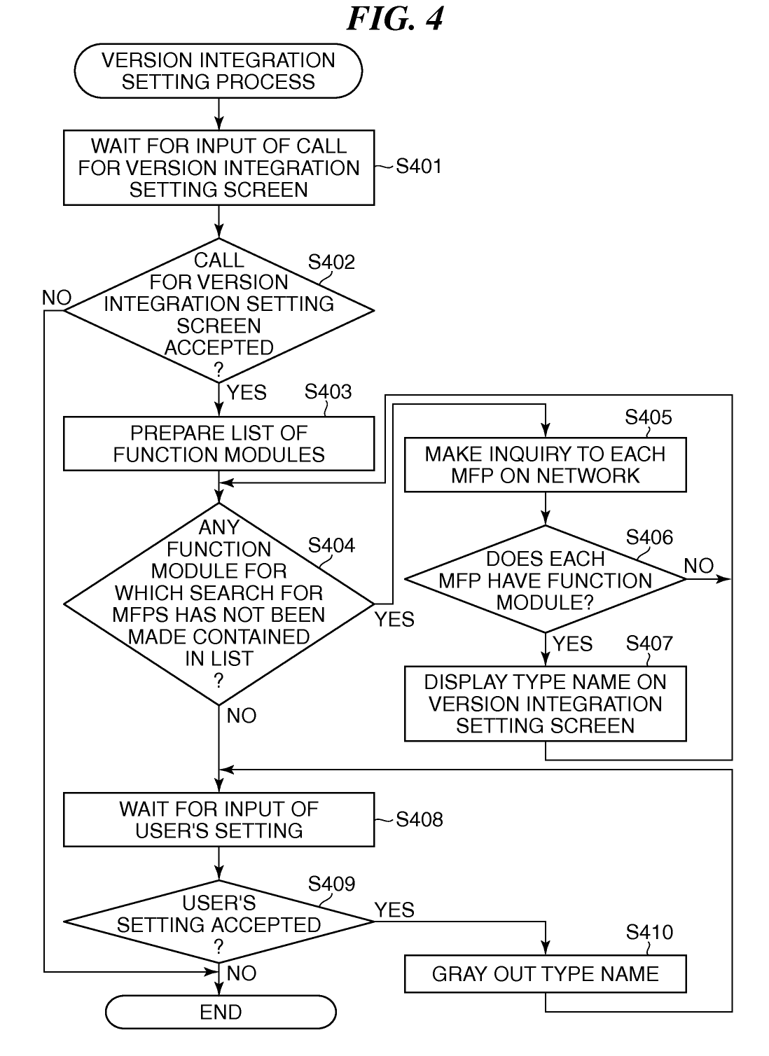

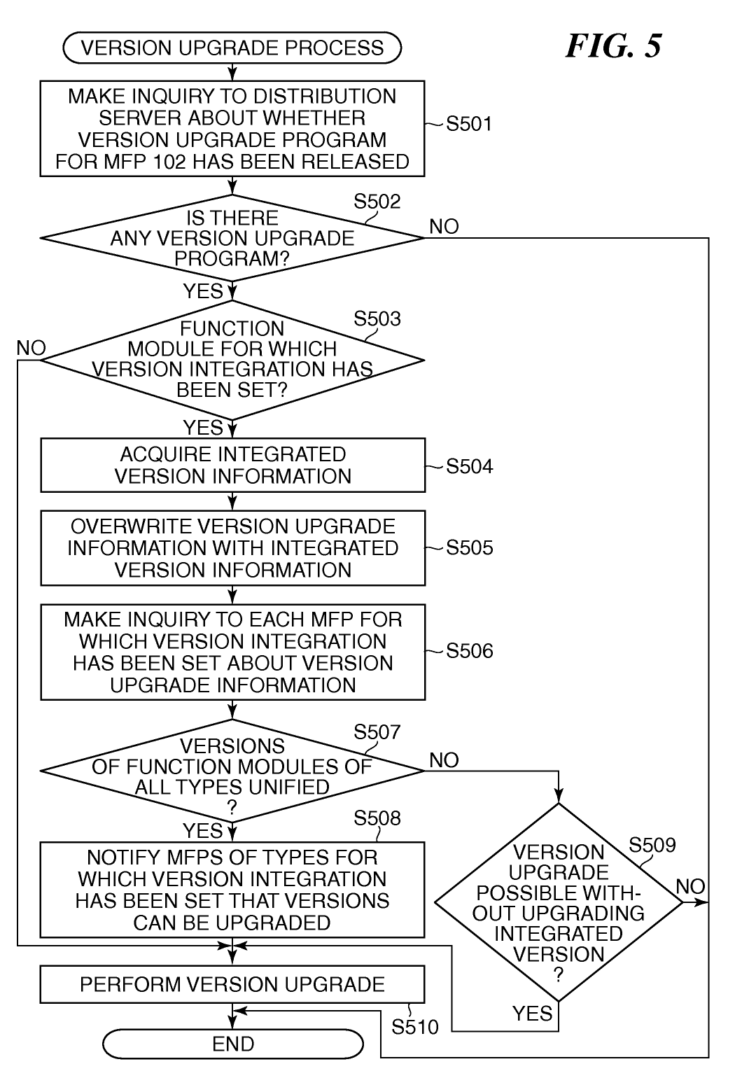

In this embodiment, as described later with reference to FIGS. 4 and 5, a version integration setting process and a version upgrade process are performed for version upgrade of function modules of MFPs, while maintaining the consistency between common function modules of MFPs which are different in type.

Next, the version integration setting process in this embodiment is described.

First, a description is given of a version integration setting screen displayed by the IO 118 of the MFP 102 in response to a call input at step S401 in the version integration setting process of FIG. 4.

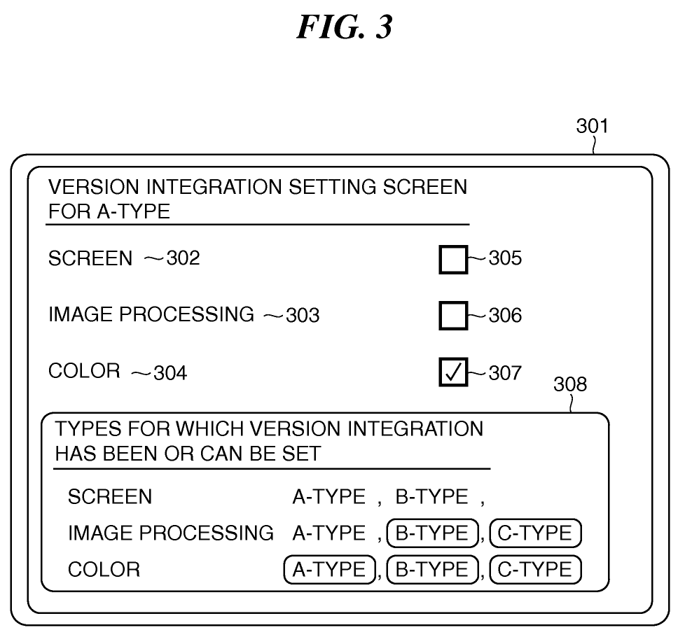

FIG. 3 shows an example version integration setting screen displayed by the IO 118 of the MFP 102.

In FIG. 3, reference numeral 301 denotes a version integration setting screen for A-type MFP, and 302 to 304 denote names of common function modules for which version integration can be set and which include a screen function module, an image processing function module, and a color function module. The screen function module is for displaying, e.g., a touch panel which is operable by the user. The image processing function module is for creating an output image based on input image information. The color function module is for creating the color of an output image. Reference numerals 305 to 307 denote checkboxes. In the version integration setting screen 301, any one or more of the checkboxes 305 to 307 can be checked to set version integration for one or more corresponding function modules. Reference numeral 308 denotes a list that indicates, on a per function module basis, MFP types for which version integration can be set and MFP types for which version integration has already been set. In the list 308, MFP types for which version integration has been set are shown by gray-out. The gray-out is a mere example, and types for which version integration has been set can be indicated in the list 308 by any indication means. As shown in the list 308, the version integration can be set between the A type and the B type in respect of the screen function module, but version integration has not been set for the screen function module in the illustrated example. For the image processing function module, the version integration can be set between the A, B, and C types, but the version integration has been set only between the B type and the C type in the example. For the color function module, the version integration can be set between the A, B and C types. In the illustrated example, the checkbox 307 is checked on the setting screen 301 for A-type MFP (and the same checkbox, not shown, is checked for each of B- and C-type MFPs), and the version integration has been set between the A, B and C types. With this selection function, the user is able to arbitrarily set the version integration for any of the common function modules. Specifically, it is possible to make the settings such that some common function module of some MFP is always version-upgraded to the latest version, whereas some other common function module is prevented from being version-upgraded until the consistency between different types of MFPs is ensured. Each of the MFPs 102 to 104 broadcasts to the network 105 a packet with header representing a version integration program and receives replies thereto, thereby storing information that represents function modules of MFPs connected to the network 105. The MFPs regularly exchange packets, whereby each MFP is able to store information representing function modules of MFPs between which version integration has been set.

FIG. 4 shows in flowchart the version integration setting process in this embodiment.

In FIG. 4, the IO 118 of the MFP 102 waits for input of a call for the version integration setting screen 301 of FIG. 3 (step S401).

Next, the CPU 111 of the MFP 102 determines whether or not a call for the version integration setting screen 301 has been accepted by the IO 118 (step S402).

If it is determined in step S402 that the call has been accepted by the IO 118 (YES to step S402), the CPU 111 causes the IO 118 to display the version integration setting screen 301 of FIG. 3, and proceeds to step S403.

In step S403, the CPU 111 executes a program stored in the nonvolatile memory 113 to find function modules installed in the MFP 102, and prepares a list of the function modules (step S403).

Next, the CPU 111 determines whether or not the list prepared in step S403 includes any function module for which a search for the MFPs connected to the network 105 has not been made (step S404).

If it is determined in step S404 that the list includes a function module for which a search has not been made (YES to step S404), the CPU 111 of the MFP 102 makes an inquiry to each of the MFPs on the network 105 about whether or not each MFP has such a function module (step S405). It should be noted that since the screen size differs between different MFP types, there is sometimes a restriction on MFP types for which version integration for screen function modules can be set. For other function modules than the screen function module, there is also a restriction on MFP types for which version integration can be set.

Next, based on a result of the inquiry in step S405, the CPU 111 of the MFP 102 determines whether or not each one of the MFPs on the network 105 has the function module in question (step S406).

If it is determined in step S406 that some MFP has such a function module (YES to step S406), the CPU 111 of the MFP 102 causes the IO 118 to display in the list 308 on the version integration setting screen 301 of FIG. 3 a type name of the MFP having that function module (step S407).

If it is determined in step S406 that all the MFPs have not the function module in question (NO to step S406), or if the display processing in step S407 is completed, the flow proceeds to step S404.

If it is determined in step S404 that the list does not include any function module for which the search has not been made (NO to step S404), the IO 118 of the MFP 102 waits for input of user's setting of version integration for any function module (step S408).

Next, the CPU 111 of the MFP 102 determines whether or not the user's setting of version integration for function module has been accepted by the IO 118 (step S409).

If it is determined in step S409 that the user's setting of version integration for function module has been accepted (YES to step S409), the CPU 111 causes the IO 118 to gray out a type name corresponding to the function module for which the setting of version integration has been accepted (here, the type name A of the MFP 102), among the type names indicated in the list 308 (step S410), and returns to step S408.

The present process is completed, if it is determined in step S402 that a call has not been accepted by the IO 118 (NO to step S402), or if it is determined in step S409 that the setting of version integration for function module has not been accepted by the IO 118 (NO to step S409).

In the following, the version upgrade process in this embodiment is described.

FIG. 5 shows in flowchart the version upgrade process in this embodiment, which is implemented according to a prescribed time schedule or an apparatus state of MFP.

The CPU 111 of the MFP 102 executes a program stored in the nonvolatile memory 113. In FIG. 5, the CPU 111 makes an inquiry to the distribution server 101 about whether a version upgrade program has been released for any of function modules of MFPs of the same type as the MFP 102, i.e., for any of function modules of the MFP 102 (step S501).

Next, based on a reply to the inquiry, the CPU 111 of the MFP 102 determines whether or not there is any version upgrade program for function module of the MFP 102 (step S502).

If it is determined in step S502 that there is a version upgrade program (YES to step S502), the CPU 111 acquires a corresponding function module name from the distribution server 101, and proceeds to step S503.

In step S503, the CPU 111 of the MFP 102 determines whether or not the function module for which the version upgrade program is present corresponds to the function module for which the version integration has been set in the version integration setting process of FIG. 4.

If it is determined in step S503 that the function module in question corresponds to the function module for which the version integration has been set (YES to step S503), the CPU 111 of the MFP 102 acquires from the distribution server 101 version information on the integrated version of the function module (integrated version information) (step S504). It should be noted that the processing in step S504 may be executed immediately before execution of the processing in step S503.

Next, the CPU 111 of the MFP 102 overwrites the version upgrade information on the MFP 102 with the integrated version information acquired in step S504 (step S505). The version upgrade information indicates that the MFP 102 (more generally, MFPs of the same type as the MFP 102) has not been version-upgraded because of difficulty in maintaining the consistency with MFPs of other types due to the fact that the version upgrade program for the function module of the MFP 102 (more generally, MFPs of the same type as the MFP 102) is present, but a version upgrade program for MFPs of other types is not present. If there is no version upgrade program for the MFP 102, the current version information on the function module of the MFP 102 serves as the version upgrade information.

Next, the CPU 111 of the MFP 102 makes an inquiry to each MFP on the network 105 about version upgrade information on its function module and receives a reply therefrom (step S506). The inquiry is sent to each of MFPs of the type for which the version integration setting has been made on the version integration setting screen 301 in FIG. 3.

Next, based on the version upgrade information acquired in step S506 from the MFPs of the type for which the version integration has been set, the CPU 111 of the MFP 102 determines whether or not the versions of function modules of all the MFP types for which the version integration has been set will be unified in a case that the function modules will be version-upgraded (step S507).

If it is determined in step S507 that the versions of all the MFP types will be unified, i.e., the version upgrade can be made while maintaining the consistency between the function modules of the MFPs which are different in type (YES to step S507), the CPU 111 of the MFP 102 notifies all the types of MFPs, on the network 105, for which the version integration has been set that the versions of all the types of MFPs can be upgraded to the same version (step S508). Each of the MFPs receiving the notification of version upgrade capability acquires from the MFP 102 information that specifies the function module whose version can be upgraded. It should be noted that such information can be received together with the version upgrade capability notification. Upon reception of the version upgrade program for the function module from the distribution server 101, each MFP overwrites the current program held in its memory with the received version upgrade program.

If it is determined in step S507 that the versions of all the types of MFPs will not be unified (NO to step S507), the CPU 111 of the MFP 102 determines whether or not version upgrade can be made without upgrading the integrated version of the function module (step S509). The above version upgrade includes update of a program that does not affect on operations between different types of MFPs, such as for example, bug fixing in the program specific to the corresponding MFP type.

If it is determined in step S503 that the function module for which the version upgrade program is present does not correspond to the function module for which the version integration has been set (NO to step S503), or if the processing in step S508 is completed, or if the version upgrade can be made without updating the integrated version (YES to step S509), the function module is version-upgraded (step S510). Specifically, the CPU 111 of the MFP 102 receives from the distribution server 101 the version upgrade program for the function module, and overwrites the current program held in the memory 112 of the MFP 102 with the received version upgrade program. It should be noted that the version upgrade program can be acquired from the distribution server 101 immediately before execution of the processing in step S503, however, from the viewpoint of memory efficiency or the like, it is preferable that the version upgrade program be acquired in the processing in step S510 to perform the version upgrade.

The present version upgrade process is completed, if it is determined in step S502 that there is no version upgrade program for function module of the MFP 102 (NO to step S502), or if it is determined in step S509 the version upgrade cannot be carried out without updating the integrated version (NO to step S509), or if the processing in step S510 is completed.

With the version integration setting process in FIG. 4 and the version upgrade process in FIG. 5, in an arrangement where a number of MFPs are connected to the same network, versions of common function modules of MFPs can be upgraded while maintaining the consistency between the MFPs. For example, in FIG. 2, the version upgrade of the color function modules of the MFPs is performed only after the integrated version of the color function module becomes the second version (ver. 2) for all the types of MFPs, whereby an undesired variation in chromaticness between different types of MFPs can be prevented. It should be noted that it is not inevitably necessary to carry out the version integration setting process in FIG. 4. Specifically, the user's selection of function modules for which version integration is to be set may be eliminated. In that case, the version integration setting can be applied to all the function modules.

In the version integration setting screen 301 of FIG. 3, the version integration is set for all the types of MFPs in respect of the color function module, but set only for the B-type and C-type MFPs in respect of the image processing function module. In that case, the A-type MFP is removed from MFPs to which an inquiry about version upgrade information is to be made in step S506 in FIG. 5. When a version upgrade program for the image processing function module is released, the image processing function module of the A-type MFP is version-upgraded irrespective of timing in which other type of MFP is version-upgraded, since version integration has not been set for the image processing function module of the A-type MFP. For the screen function module or other function module for which version integration has not been set for any type of MFP, version upgrade is performed on a per MFP type basis.

Next, an information processing system having image processing apparatuses according to a second embodiment is described.

The information processing system of this embodiment differs from the first embodiment only in that a particular type of MFPs on the same network will never be version-upgraded. A duplicated description of the construction and function common to the embodiments will be omitted, and only a description of the construction and function different from the first embodiment is given below.

In a case that the version upgrade of a particular type of MFPs on the same network will never be performed, if version integration is set between the particular type of MFPs and other types of MFPs, the other types of MFPs will also never be version-upgraded, which causes an inconvenience.

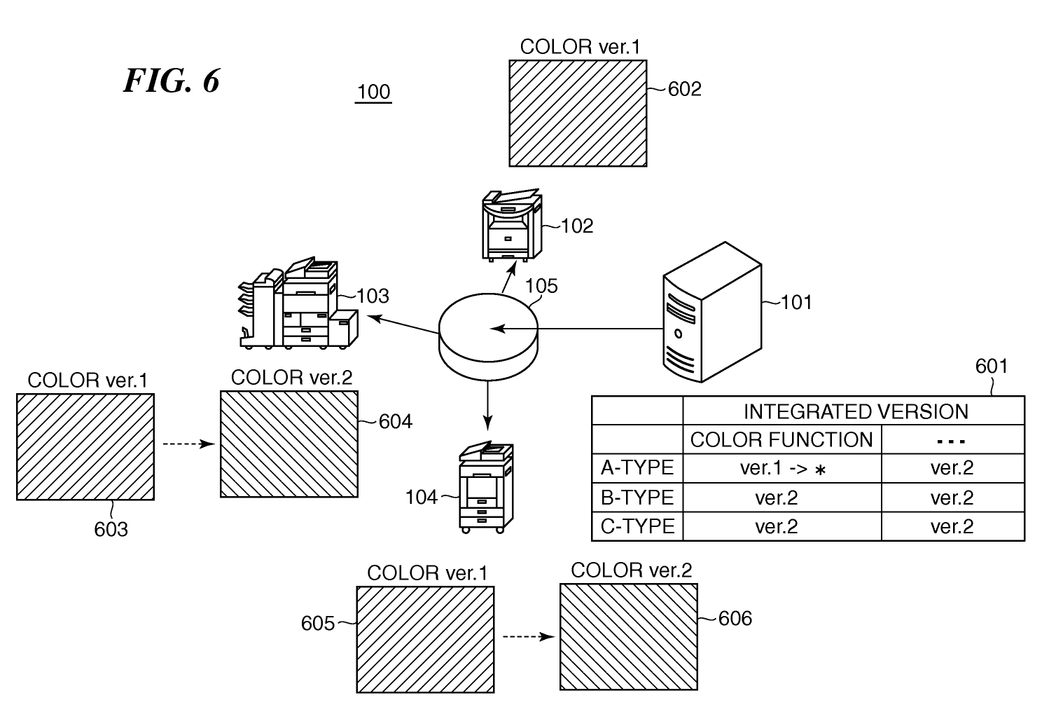

FIG. 6 explains an inconvenience caused when the A-type MFP 102 on the network 105 in the information processing system 100 will never be version-upgraded.

As shown in FIG. 6, the distribution server 101, A-type MFP 102, B-type MFP 103, and C-type MFP 104 are connected via the network 105 to one another.

Reference numeral 601 denotes version information stored in the memory 107 of the distribution server 101. The version information can be distributed to the MFPs 102 to 104, and represents versions of function module programs which can be distributed to the MFPs 102 to 104. In the version information 601, an asterisk indicates a function module for which a version upgrade program will never be released.

Reference numeral 602 denotes an example output image obtained when the integrated version of the color function module of the A-type MFP 102 is a first version (ver. 1). Reference numerals 603 and 604 denote example output images obtained when the integrated version of the color function module of the B-type MFP 103 is a first version (ver. 1) and a second version (ver. 2), respectively. Reference numerals 605 and 606 denote example output images obtained when the integrated version of the color function module of the C-type MFP 104 is a first version and a second version, respectively.

It is assumed here that version upgrade programs of a second integrated version for the color function modules of the B-type and C-type MFPs 103, 104 have been released and held by the distribution server 101, and that version integration has been set between the color function modules of the A, B and C types of MFPs. In that case, if the development of the color function module of the A-type MFP has been completed and a version upgrade program for that module will no longer be released, i.e., if the version upgrade thereof has been completed, an inconvenience is caused that it will no longer be possible to version-upgrade the color function modules of the B and C types of MFPs for which version integration with the A type MFP has been set.

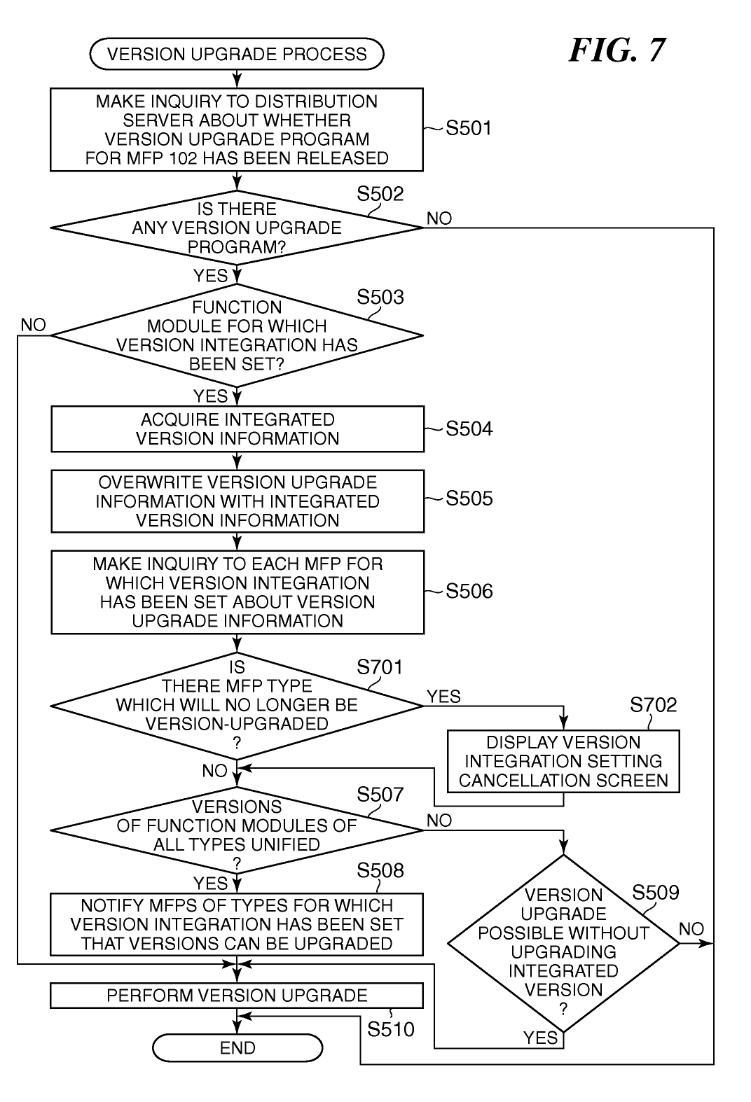

In this embodiment, a version upgrade process is carried out as described later with reference to FIG. 7, to avoid an inconvenience that, if a particular type of MFP on the network 105 will no longer be version-upgraded, other types of MFPs will never be version-upgraded.

The following is a description of the version upgrade process.

FIG. 7 shows in flowchart the version upgrade process in this embodiment, which is basically the same as the version upgrade process in FIG. 5 and only differs in that processing in steps S701 and S702 is carried out immediately after execution of processing in step S506. In the following, a description is given of only the different processing and describes a case where the A-type MFP 102 will never be version-upgraded and the B-type MFP 103 carries out the version upgrade process.

It should be noted that the developer releases information about the function module for which a version upgrade program will no longer be released. Such information can be stored into the memory 107 of the distribution server 101 via the network 105. Alternatively, information in the memory 107 can be rewritten directly by a service personnel. The method to rewrite the memory 107 is not limitative.

As shown in FIG. 7, processing from steps S501 to S506 already described in the version upgrade process in FIG. 5 is carried out.

Next, the CPU (not shown) of the MFP 103 executes a program stored in a nonvolatile memory (not shown) to acquire version upgrade information representing types of MFPs on the network 105 for which version integration has been set and determine whether or not there is an MFP type which will no longer be version-upgraded (step S701).

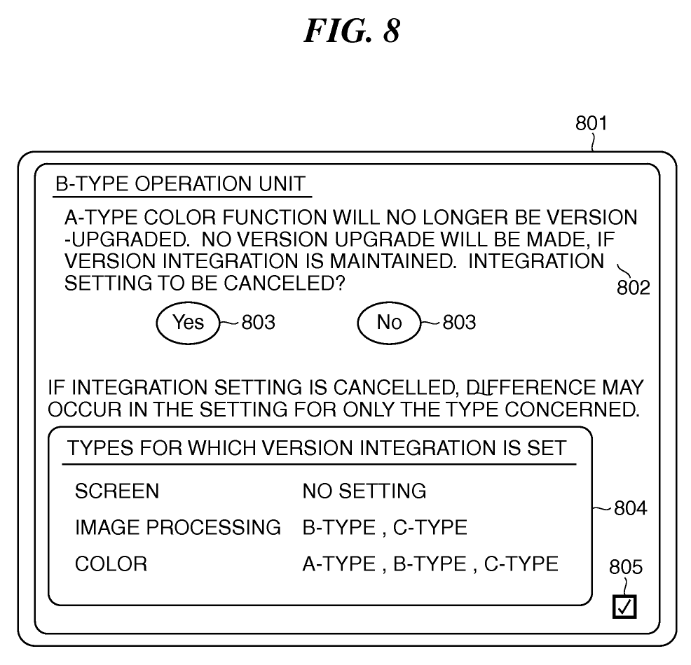

If it is determined in step S701 that there is an MFP type which will no longer be version-upgraded (YES to step S701), the CPU causes an IO (not shown) of the MFP 103 to display a version integration setting cancellation screen 801 of FIG. 8 (step S702).

FIG. 8 shows an example version integration setting cancellation screen for B-type MFP displayed by the IO of the MFP 103 in step S702.

In FIG. 8, reference numeral 801 denotes the version integration setting cancellation screen, and 802 denotes a warning stating that version upgrade will never be performed, if the version integration setting is maintained. Reference numeral 803 selection buttons for selectively removing, from the version integration setting, the MFP type which will no longer be version-updated. Such MFP type is removed from the version integration setting when a “YES” button is operated, whereas the setting is kept effective when a “NO” button is operated. Reference numeral 804 denotes a list in which MFP types for which the version integration has been set are indicated on a per function module basis. With the list, the user is able to confirm a current state of version integration setting. Reference numeral 805 denotes a checkbox for preventing the screen 801 from being displayed. By checking the checkbox 805, it is possible to intentionally prohibit the screen 801 from being displayed.

Referring to FIG. 7 again, if it is determined in step S701 that there is no MFP type which will no longer be version-updated (NO to step S701) or if the processing in step S702 is completed, the processing in steps S507 to S510 is carried out as with the version upgrade process in FIG. 5, and the version upgrade process is completed.

With the version upgrade process in FIG. 7, it is possible to notify the user that version upgrade will never be performed due to version integration setting, and permit the user to selectively cancel the version integration setting. Therefore, even if a particular type of MFP on the network 105 will never be version-upgraded, it is possible to avoid an inconvenience that other type MFPs will not be version-upgraded.

Next, an information processing system having a distribution server according to a third embodiment of this invention is described.

The information processing system of this embodiment is basically the same in construction and operation as the first and second embodiments, and therefore a duplicative description of the construction and operation common to these embodiments will be omitted, and only different construction and operation will be described below. In this embodiment, the distribution server manages MFPs on the same network, which are grouped on a per function-module basis.

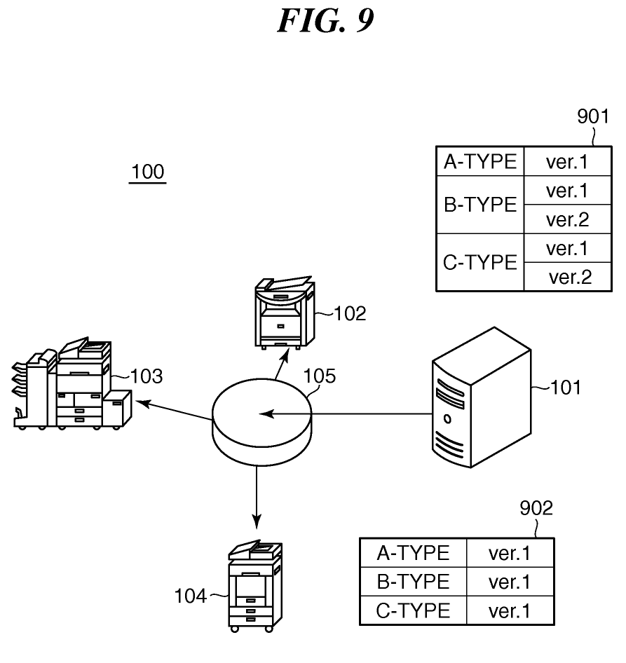

FIG. 9 schematically shows the construction of the information processing system of this embodiment.

As shown in FIG. 9, the distribution server 101, A-type MFP 102, B-type MFP 103, and C-type MFP 104 are connected with one another via the network 105.

Reference numeral 901 denotes version information stored in the memory 107 of the distribution server 101. The version information can be distributed to the MFPs 102 to 104, and represents versions of color function module programs which can be distributed to the MFPs 102 to 104. Reference numeral 902 denotes version upgrade programs released from the distribution server 101 to the MFPs on the network 105. The distribution server 101 has a function of acquiring information on MFPs on the network 105 and grouping MFPs on a per function-module basis. Based on grouping information and the version information 901 on distributable programs, the distribution server 101 determines the version of each version upgrade program to be released and unifies the versions of function modules of grouped MFPs into one. After the versions of function modules of MFPs belonging to one group are unified into one, the distribution server 101 releases the corresponding version upgrade program, making it possible to match timings in which function modules of different types of MFPs are version-upgraded.

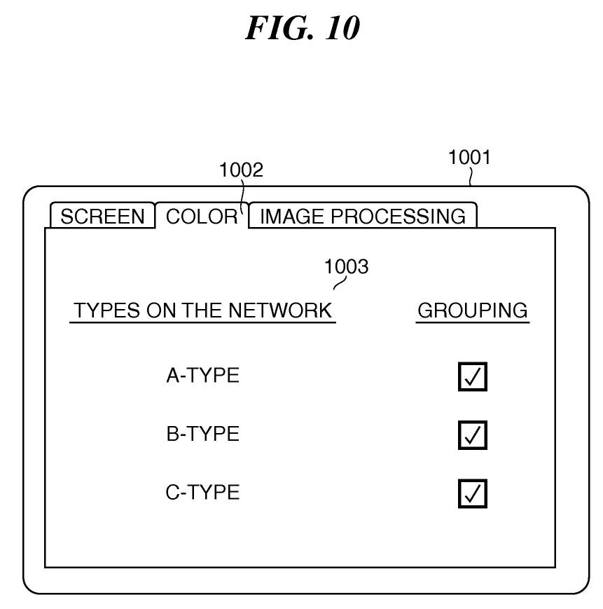

FIG. 10 shows an example grouping setting screen displayed by the IO 110 of the distribution server in the information processing system 100 in FIG. 9. It should be noted that the distribution server 101 broadcasts a dedicated packet to the network 105, receives replies thereto, and stores information indicating MFP types on the network 105.

In FIG. 10, reference numeral 1001 denotes a grouping setting screen, 1002 denotes tabs used for displaying, on a per function-module basis, distributable programs stored in the memory 107, and 1003 denotes an example grouping setting screen for displaying information on types of MFPs on the network 105 based on MFP type information acquired in advance. One or more MFP types can be selected using checkboxes, and the selected MFP types constitute a function module group. Thus, grouping can be set on a per function-module basis.

Next, a version upgrade program release process of this embodiment is described.

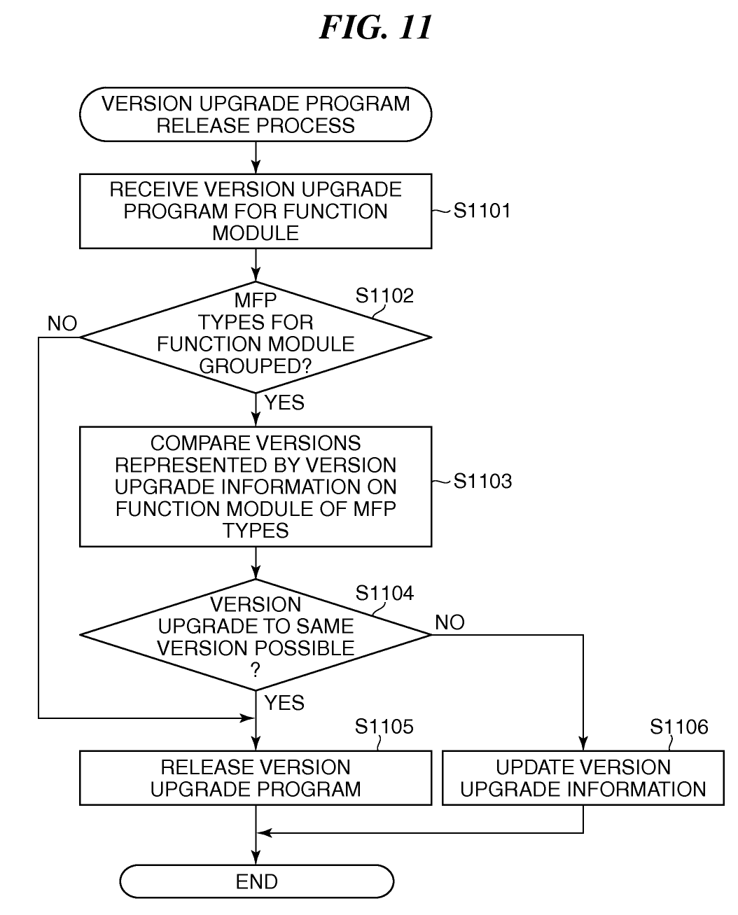

FIG. 11 shows in flowchart the version upgrade program release process in this embodiment.

In FIG. 11, the CPU 106 of the distribution server 101 executes a program stored in the memory 107, receives a version upgrade program for each function module, and stores the received version upgrade program into the HD 108 (step S1101). It should be noted that the version upgrade program can be received via the network communication unit 109, or can directly be rewritten by a service personnel.

Next, the CPU 106 of the distribution server 101 determines whether or not a group of MFP types for the function module corresponding to the received version upgrade program has been constituted (step S1102).

If it is determined in step S1102 that a group of MFP types for the function module has been constituted (YES to step S1102), the CPU 106 compares versions with one another, which are represented by version upgrade information on the function module of MFP types belonging to that group (step S1103).

Next, based on a result of the comparison in step S1103, the CPU 106 determines whether or not the versions of all the MFP types can be upgraded to the same version (step S1104).

If it is determined in step S1102 that no group of MFP types for the function module has been constituted (NO to step S1102) or if it is determined in step S1104 that the versions can be upgraded to the same version (YES to step S1104), the CPU 106 of the distribution server 101 releases a version upgrade program for the function module on a per MFP type group basis (step S1105). Each of MFPs, having the function module for which the version upgrade program has been released, downloads the version upgrade program from the distribution server 101. It should be noted that the version upgrade program can be distributed to the MFPs at the initiative of the distribution server 101.

If it is determined in step S1104 that the versions cannot be upgraded to the same version (NO to step S1104), the CPU 106 of the distribution server 101 replaces the version upgrade information on the function module with version information on the received version upgrade program (step S1106).

After completion of the processing in steps S1105 and S1106, the present process is completed.

With the version upgrade program release process in FIG. 11, timings in which function modules of different types of MFPs are version-upgraded can be matched to one another.

Next, a description will be given of a version upgrade process executed by an image processing apparatus according to a fourth embodiment of this invention.

This embodiment is basically the same in construction and operation as the first to third embodiments, and different construction and operation are described below.

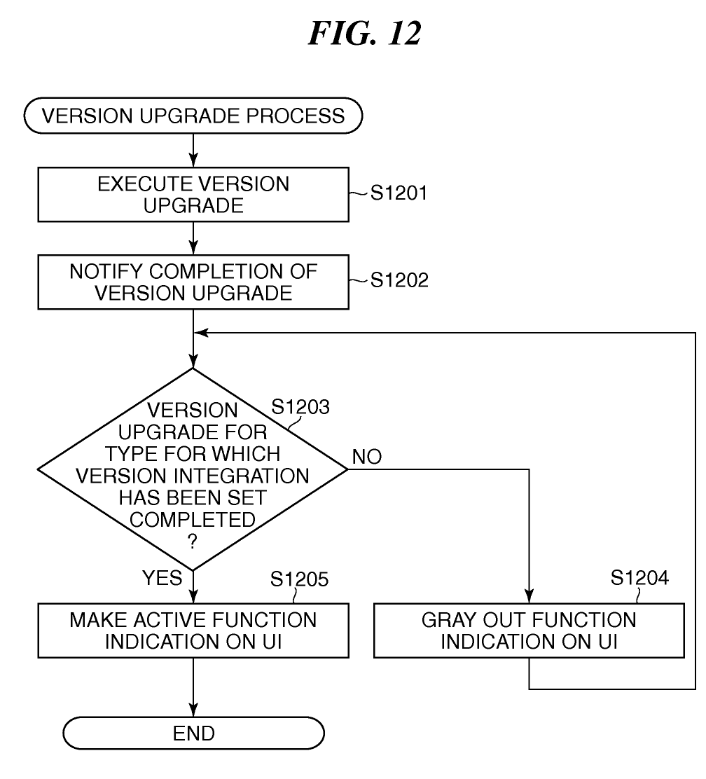

FIG. 12 shows in flowchart a version upgrade process in this embodiment.

In FIG. 12, the CPU 111 of the MFP 102 executes a program stored in the nonvolatile memory 113 to upgrade the version of a function module (step S1201). Specifically, the CPU 111 receives a version upgrade program from the distribution server 101 and overwrites a current program held in the memory 112 of the MFP 102 with the received program.

After completion of the version upgrade of the function module, the CPU 111 of the MFP 102 notifies types of MFPs on the network 105 for which version integration has been set that the function module has been version-upgraded (step S1202). Each of the MFPs receiving the version upgrade completion notification stores the notification along with information representing the MFP from which the notification has been sent.

Next, the CPU 111 of the MFP 102 determines whether or not the version upgrade for the function module has been completed in each of MFPs of types for which version integration has been set (step S1203). Specifically, the CPU determines whether or not it has received a version upgrade completion notification (version upgrade progress status information) from each of the MFPs of types for which the version integration has been set, thereby determining whether or not other types of MFPs have been version-upgraded.

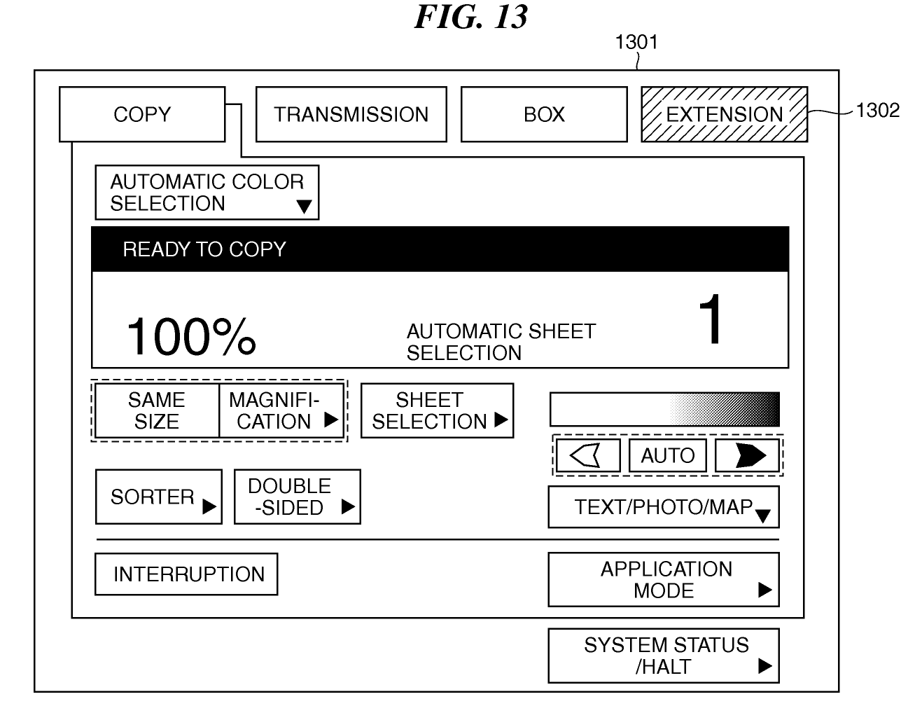

If it is determined in step S1203 that the version upgrade of the function module has not been completed (NO to step S1203), the CPU 111 of the MFP 102 grays out or does not display a function indication on UT in the IO 118 (UI indication), which corresponds to a function of the function module (step S1204), and then returns to step S1203. In a case for example that by the version upgrade of the function module, an extension button 1302 is added as shown in FIG. 13 to the UI screen 1301 for accepting user's input, the extension button 1302 is grayed out in step S1204, thereby temporarily preventing the extension button 1302 from being used by the user.

If it is determined in step S1203 that the version upgrade for the function module has been completed (YES to step S1203), the CPU 111 of the MFP 102 makes active the function indication on the UI of the IO 118 corresponding to the function module (step S1205), thereby permitting the user to use the corresponding function.

After completion of the processing in step S1205, the present process is completed.

With the version upgrade process in FIG. 12, the user cannot utilize the function of the function module of MFPs until the version upgrade of all the types of MFPs for which version integration has been set has been normally completed. As a result, it is possible to reduce a time period in which there is a version difference between different types of MFPs and thereby maintain the consistency between the different types of MFPs.

In the version upgrade process in FIG. 12, each of the MFPs on the network 105 holds information on other MFPs each having a function module for which version integration has been set, and MFPs to which a version upgrade completion notification is to be sent are determined in step S1202 based on the information on the other MFPs. However, in a case that MFPs are grouped on a per function module basis and the grouped MFPs are managed by the distribution server 101, such can be realized by causing each of MFPs belonging to one group to send a version upgrade completion notification to the distribution server 101 in step S1202, by causing the distribution server 101 to determine whether or not the version upgrade of each of MFPs belonging to that group has been completed in step S1203, and by causing the distribution server 101 to notify a result of the determination to each of the MFPs belonging to the group.

It should be noted that a condition in which the MFP 102 determines whether a version upgrade completion notification has been received from each of MFPs other than the MFP 102 can be changed according to a type of function module. For example, in the case of a function module having a function achieved by cooperation of two or more MFPs, the function becomes usable after completion of the version upgrade of all these MFPs. When it is determined in step S1203 that version upgrade completion notifications from all the two or more MFPs have been received, the process proceeds to step S1205 in which the function is made active.

Next, an information processing system including image processing apparatuses according to a fifth embodiment of this invention is described.

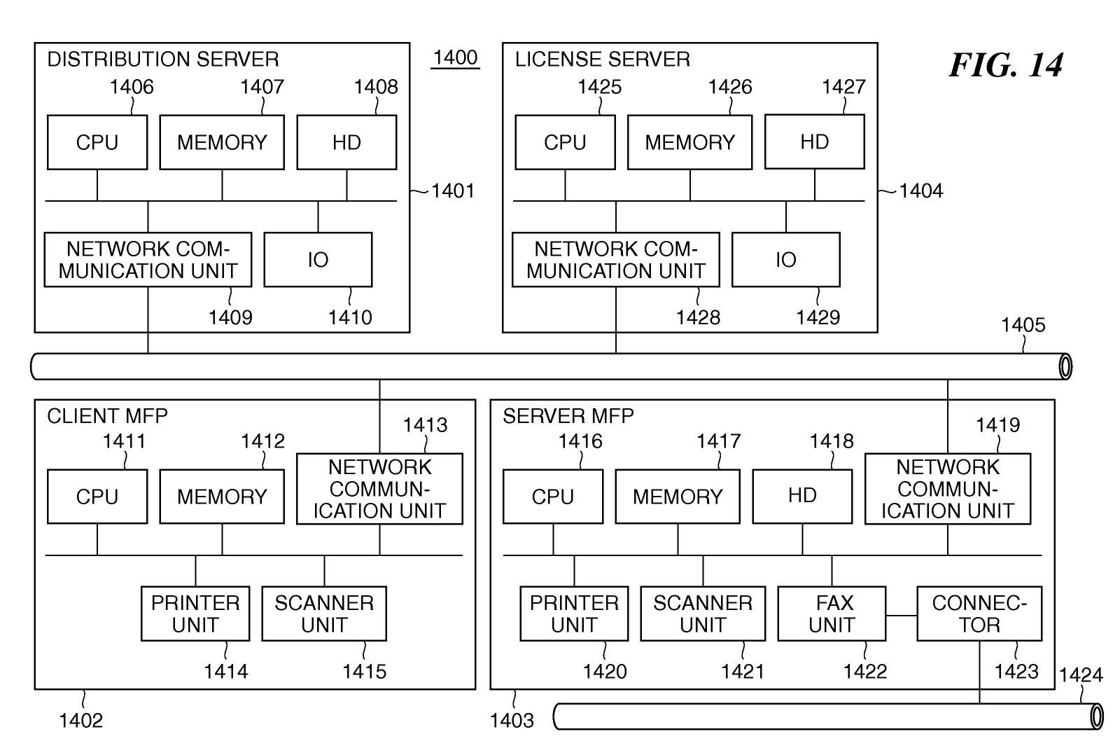

FIG. 14 shows in block diagram the construction of the information processing system including image processing apparatuses of this embodiment.

As shown in FIG. 14, the information processing system 1400 includes a distribution server 1401, a client MFP 1402, a server MFP 1403, and a license server 1404, which are connected via a network 1405 to one another. The distribution server 1401 holds programs for function modules of the MFPs 1402, 1403.

The distribution server 1401 includes a CPU 1406, a memory 1407, a hard disk (HD) 1408, a network communication unit 1409, and an input/output unit (IO) 1410.

The CPU 1406 executes the procedure for the distribution server 1401. The memory 1407 stores procedure for the distribution server 1401 and version upgrade information on programs held by the HD 1408 for function modules of the MFPs 1402, 1403. The HD 1408 holds the function module programs of the MFPs 1402, 1403. The IO 1410 is comprised of input devices such as a keyboard and a mouse and an output device such as a monitor.

The client MFP 1402 includes a CPU 1411, a memory 1412, a network communication unit 1413, a printer unit 1414, and a scanner unit 1415.

The CPU 1411 executes procedure for the client MFP 1402. The memory 1412 stores procedure for the client MFP 1402 and information representing function modules of the client MFP 1402. The printer unit 1414 outputs an image. The scanner unit 1415 reads an image.

The server MFP 1403 includes a CPU 1416, a memory 1417, a hard disk (HD) 1418, a network communication unit 1419, a printer unit 1420, a scanner unit 1421, a FAX unit 1422, and a connector 1423.

The CPU 1416 executes procedures for the server MFP 1403. The memory 1417 stores the procedures for the server MFP 1403 and information representing function modules of the server MFP 1403. The HD 1418 stores image data, etc. The printer unit 1420 outputs an image. The scanner unit 1421 reads an image. The FAX unit 1422 creates and transmits FAX data to a telephone line network 1424 via a connector 1423 connected thereto.

The license server 1404 includes a CPU 1425, a memory 1426, a hard disk (HD) 1427, a network communication unit 1428, and an input/output unit (IO) 1429.

The CPU 1425 executes procedures for the license server 1404. The memory 1426 stores the procedures for the license server 1404 and version upgrade information on programs, held by the HD 1427, for function modules of the MFPs 1402, 1403. The HD 1427 holds the function module programs of the MFPs 1402, 1403. The IO 1429 is comprised of an input device such as a keyboard and a mouse and an output device such as a monitor.

The network 1405 is implemented by the Internet, a telephone line network, an ISDN line network, a dedicated line, an optical line network, a wireless communication network, or the like.

In the information processing system 1400, the distribution server 1401 consists of, e.g., a printer server for managing a number of MFPs placed at a location. The distribution server 1401 is connected to an MFP manufacture's server (not shown), and downloads from the manufacturer's server a version upgrade program of any of the MFPs managed by the distribution server 1401 when the version upgrade program is released. The distribution server 1401 temporarily holds the downloaded version upgrade program in the HD 1408, and manages programs for function modules of the MFPs 1402, 1403.

The MFPs 1402, 1403 usually monitor the distribution server 1401 at regular intervals. When a version upgrade program for any of function modules of MFP types is released, the corresponding MFP downloads the version upgrade program from the distribution server 1401 and upgrades the version of the corresponding function module.

In the information processing system 1400, the client MFP 1402 is able to request the server MFP 1403 to execute a FAX transmission process, etc. for the MFP 1402. However, if the FAX function of the server MFP 1403 to perform the FAX transmission process is disabled, FAX transmission cannot be carried out by the server MFP 1403. In that case, there is a fear that the user who has requested via the client MFP 1402 the server MFP 1403 to execute the FAX transmission misunderstands that the FAX transmission has been or will be made.

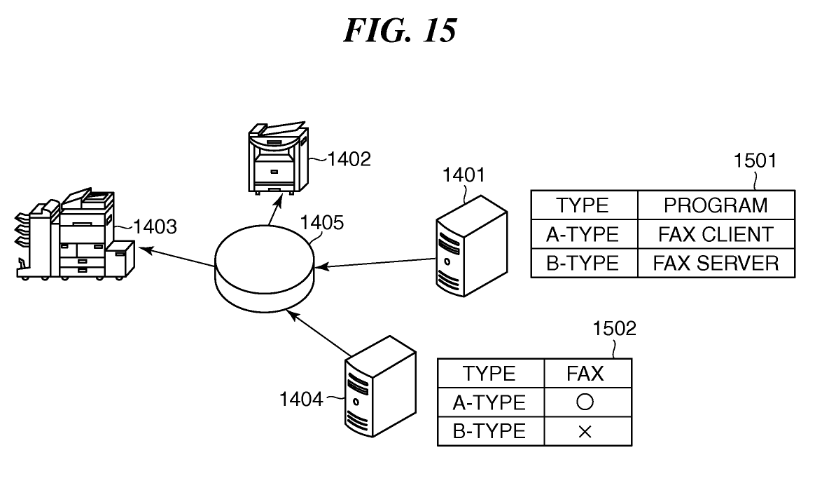

FIG. 15 explains a case that a function of the server MFP 1403 is not executable in the information processing system 1400 in FIG. 14 and a user misunderstands that the function is executable.

As shown in FIG. 15, the distribution server 1401, A-type client MFP 1402, B-type server MFP 1403, and license server 1404 are connected to one another via the network 1405.

Reference numeral 1501 denotes information stored in the memory 1407 of the distribution server 1401 and representing function module programs which can be distributed to the MFPs 1402, 1403. A FAX client program is released for A-type MFPs, and a FAX server program is released for B-type MFPs.

Reference numeral 1502 denotes license status information on the MFPs 1402, 1403, which is stored in the memory 1426 of the license server 1404. A FAX client program license is valid for A-type MFPs, and a FAX server program license is invalid for B-type MFPs.

The client MFP 1402 does not have a FAX function, and therefore requests the server MFP 1403 to execute alternate processing for FAX transmission process. The client MFP 1402 downloads the FAX client program from the distribution server 1401 and installs the FAX client program. In the license server 1404, the license of FAX client program is valid, and therefore a FAX client function is executable.

The server MFP 1403 has a FAX function and executes a FAX transmission process for the client MFP 1402. The server MFP 1403 downloads the FAX server program from the distribution server 1401 and installs the FAX server program. In the license server 1404, the license of FAX server program is not valid, and therefore a FAX server function is not executable.

In that case, the user is able to request via the client MFP 1402 the server MFP 1403 to execute alternate processing, so that a FAX transmission process is performed by the server MFP 1403 on the behalf of the client MFP 1402. However, the FAX server function of the server MFP 1403 for performing the FAX transmission process is not executable, and therefore the server MFP 1403 cannot perform FAX transmission, causing a fear that the user who has requested via the client MFP 1402 the server MFP 1403 to execute the alternate processing misunderstands that FAX transmission has been or will be carried out. Even if a message to that effect is displayed on an operation unit of the client MFP 1402, the user recognizes that FAX transmission cannot be sent only after a request for alternate processing has been made by the user.

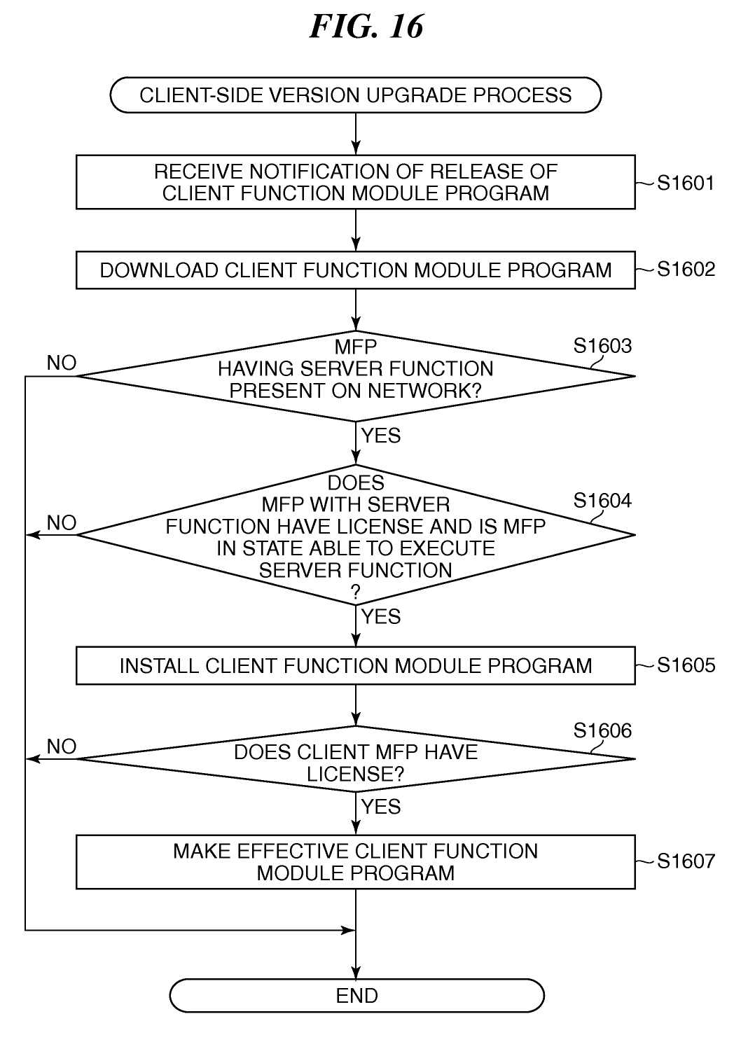

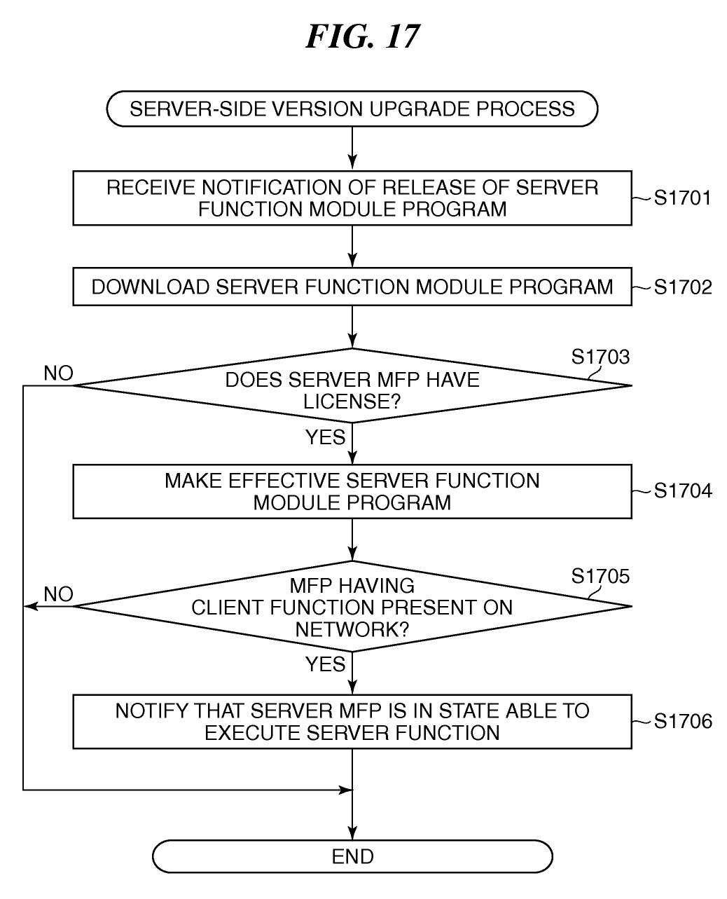

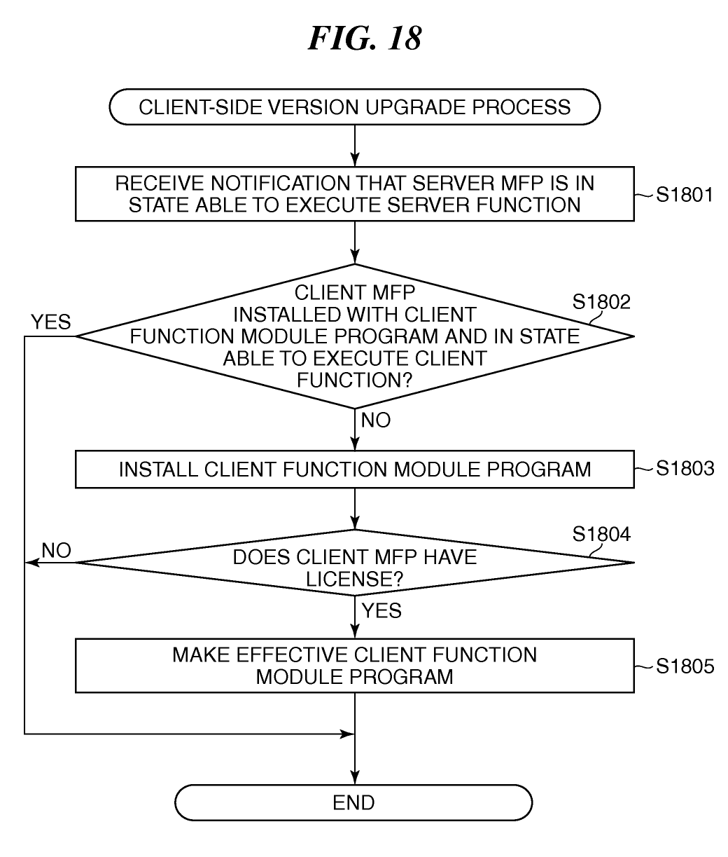

In this embodiment, a client-side version upgrade process described below with reference to FIGS. 16 and 18 and a server-side version upgrade process described below with reference to FIG. 17 are executed for version upgrade of function modules of MFPs, while maintaining the consistency between the MFP requesting alternate processing and the MFP requested to execute the alternate processing.

Next, the client-side version upgrade process in this embodiment is described.

FIG. 16 shows in flowchart the client-side version upgrade process in this embodiment.

In FIG. 16, the CPU 1411 of the client MFP 1402 executes a program stored in the memory 1412, and receives from the distribution server 1401 a notification of release of a client function module program (step S1601). The release notification can be sent from the distribution server 1401. Alternatively, the client MFP 1402 can inquire the distribution server about it.

Next, the CPU 1411 of the client MFP 1402 downloads the client function module program from the distribution server 1401 (step S1602). The download can be made under the initiative of the client MFP 1402 or the distribution server 1401.

Next, the CPU 1411 determines whether or not an MFP having a server function is present on the network 1405 (step S1603). Specifically, the CPU 411 inquires each of MFPs on the network 1405 about whether each MFP has a server function and carries out a determination based on replies from the MFPs.

If it is determined in step S1603 that there is an MFP having a server function (YES to step S1603), the CPU 1411 determines whether or not that MFP has a license for server function program and is in a state able to execute the server function (step S1604). Specifically, the CPU 1411 inquires the MFP having a server function about whether it has a license and is in a state able to execute the server function and carries out a determination based on a reply from the MFP.

If it is determined in step S1604 that the MFP having a server function has a license for server function program and is in a state able to execute the server function (YES to step S1604), the CPU 1411 installs the client function module program downloaded from the distribution server 1401 (step S1605).

Next, the CPU 1411 determines whether or not the client MFP 1402 has a license for the installed client function module program (step S1606). Specifically, the CPU 1411 inquires the license server 1404 about a license status of the installed client function module program and carries out a determination based on a reply therefrom.

If it is determined in step S1606 that the client MFP 1402 has a license (YES to step S1606), the CPU 1411 makes effective the installed client function module program so that the program is made executable (step S1607).

The present process is completed, if it is determined in step S1603 that there is no MFP having a server function (NO to step S1603), or if it is determined in step S1604 that the MFP having a server function has the license but is not in a state able to execute the server function (NO to step S1604), or if it is determined in step S1606 that the MFP having a server function has no license (NO to step S1606), or if the processing in step S1607 is completed.

With the client-side version upgrade process in FIG. 16, when the function of the server MFP 1403 is not executable, the client MFP 1402 downloads but does not install a function module program, making it possible to prevent in advance the user from erroneously using the function of that function module.

Next, the server-side version upgrade process in this embodiment is described.

FIG. 17 shows in flowchart the server-side version upgrade process in this embodiment.

In FIG. 17, the CPU 1416 of the server MFP 1403 executes a program stored in the memory 1417 and receives a notification of release of a server function module program from the distribution server 1401 (step S1701). The release notification can be sent from the distribution server 1401 or inquired from the server MFP 1403.

Next, the CPU 1416 downloads a server function module program from the distribution server 1401 (step S1702). The download can be made under the initiative of the server MFP 1403 or the distribution server 1401.

Next, the CPU 1416 determines whether or not the server MFP 1403 has a license for the installed server function module program (step S1703). Specifically, the CPU 1416 inquires the license server 1404 about a license status of the installed server function module program and performs a determination based on a reply from the license server.

If it is determined in step S1703 that the server MFP 1403 has a license (YES to step S1703), the CPU 1416 makes effective the installed server function module program so that the program is made executable (step S1704).

Next, the CPU 1416 determines whether or not an MFP having a client function is present on the network 1405 (step S1705). Specifically, the CPU 1416 inquires each of MFPs on the network 1405 about whether each MFP has a client function and performs a determination based on replies from the MFPs.

If it is determined in step S1705 that there is an MFP having a client function (YES to step S1705), the CPU 1416 notifies the MFP that the server MFP 1403 is in a state able to execute the server function (step S1706).

Next, another client-side version upgrade process in this embodiment is described.

FIG. 18 shows in flowchart the client-side version upgrade process in this embodiment.

In FIG. 18, the CPU 1411 of the client MFP 1402 executes a program stored in the memory 1412 and receives a notification from the server MFP 1403 that the server MFP 1403 is in a state able to execute a server function (step S1801).

Next, the CPU 1411 determines whether or not the client MFP 1402 has been installed with a client function module program and is in a state able to execute a client function (step S1802).

If it is determined in step S1802 that the client MFP 1402 has not been installed with the client function module program and is not in a state able to execute the client function (NO to step S1802), the CPU 1411 of the client MFP 1402 downloads the client function module program from the distribution server 1401 and installs the program (step S1803).

Next, the CPU 1411 determines whether or not the client MFP 1402 has a license for the installed program (step S1804). Specifically, the CPU 1411 inquires the license server 1404 about a license status of the installed program and performs a determination based on a reply therefrom.

If it is determined in step S1804 that the client MFP 1402 has a license (YES to step S1804), the CPU 1411 makes effective the installed program so that the client MFP 1402 is brought to a state able to execute the client function (step S1805).

The present process is completed, if it is determined in step S1802 that the client MFP 1402 has been installed with the client function module and is in a state able to execute the client function (YES to step S1802), or if it is determined in step S1804 that the client MFP 1402 has no license (NO to step S1804), or if the processing in step S1805 is completed.

With the client-side version upgrade process of FIGS. 16 and 18 and the server-side version upgrade process of FIG. 17, the function module of the MFP requesting alternate processing and the function module of the MFP requested to execute the alternate processing can be version-upgraded, while maintaining the consistency between the function modules of these MFPs. In addition, the consistency between versions of function modules can be maintained in consideration of a license for each function module program.

It is to be understood that the present invention may also be accomplished by supplying a system or an apparatus with a storage medium in which a program code of software, which realizes the functions of the above described embodiments is stored and by causing a computer (or CPU or MPU) of the system or apparatus to read out and execute the program code stored in the storage medium. In that case, the program code itself read from the storage medium realizes the functions of the above described embodiments, and therefore the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. The program code may be downloaded via a network.

Further, it is to be understood that the functions of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-164698, filed Jun. 24, 2008, which is hereby incorporated by reference herein in its entirety.

What is claimed is:

1. An image processing apparatus connected via a network to a distribution server for at least distributing a program for the image processing apparatus, comprising:
a reception unit adapted, in a case where a version upgrade program for a function module of a type corresponding to the image processing apparatus is present in the distribution server, to receive integrated version information on the version upgrade program from the distribution server, the integrated version information being used for unifying functions of function modules of image processing apparatuses of different types on the network;
an update unit adapted to update, based on the integrated version information received by said reception unit, version upgrade information indicating a version to which the function module of the image processing apparatus can be upgraded;
an acquisition unit adapted to acquire version upgrade information on the function module of at least one other image processing apparatus of different type on the network; and
a determination unit adapted to determine, based on the version upgrade information updated by said update unit and the version upgrade information acquired by said acquisition unit, whether the function module of the image forming apparatus should be version-upgraded.

2. The image processing apparatus according to claim 1, including:
a plurality of function modules; and
an execution unit adapted to upgrade versions of the function modules of the image processing apparatus on a per function-module basis.

3. The image processing apparatus according to claim 1, including:
a setting unit adapted to selectively set at least one other image processing apparatus of different type, on the network, having a function module whose function should be unified with that of the function module of the image forming apparatus,
wherein said the determination unit determines, based on version upgrade information on the at least one other image processing apparatus of different type set by said setting unit, whether the function module of the image forming apparatus should be version-upgraded.

4. The image processing apparatus according to claim 3, including:
a discrimination unit adapted to discriminate, among the at least one other image processing apparatus of different type set by said setting unit, a type of image processing apparatus for which the function module will be no longer version-upgraded; and
a cancellation unit adapted, in a case where the type of image processing apparatus discriminated by said discrimination unit has been set by said setting unit, to cancel setting of that type of image processing apparatus by said setting unit.

5. The image processing apparatus according to claim 1, including:
a notification unit adapted to notify at least one other apparatus on the network based on the integrated version information that the function module of the image processing apparatus has been version-upgraded after completion of version upgrade of the function module of the image processing apparatus; and
a user interface display unit adapted to confirm a status of progress of version upgrade of each of the at least one other apparatus on the network and adapted, in a case where it is confirmed that the version upgrade of at least one other apparatus has not been completed, to gray-out or not to display an indication of a function corresponding to the version upgrade on a user interface.

6. A distribution server connected to image processing apparatuses via a network and adapted to distribute programs for the image processing apparatuses, comprising:
a grouping unit adapted to group the image processing apparatuses on the network on a per function-module basis;
a hold unit adapted to hold version upgrade programs for function modules of the image processing apparatuses;
a determination unit adapted to determine whether or not each of the version upgrade programs should be released, on a per image processing apparatus group basis, based on integrated version information on the version upgrade programs used for unifying functions of function modules of image processing apparatuses of different types; and
a release unit adapted to release, to the network, at least one of the version update programs which is determined by said determination unit to be released.

7. An image processing apparatus connected via a network to a distribution server for at least distributing a program for the image processing apparatus and a license server for at least managing a license for the program, comprising:
a download unit adapted to download the program from the distribution server;
a first determination unit adapted to determine whether or not the downloaded program should be installed into the image processing apparatus based on a license status of the program in an apparatus that operates in conjunction with the image processing apparatus;
an installation unit adapted to install the downloaded program into the image processing apparatus in a case where said first determination unit determines that the downloaded program should be installed thereinto;
a second determination unit adapted to determine, based on a license status of the installed program in the image forming apparatus, whether or not the installed program should be made executable; and
a state alteration unit adapted to make the installed program executable in a case where said second determination unit determines that the installed program should be made executable.

8. A control method for an image processing apparatus connected via a network to a distribution server for at least distributing a program for the image processing apparatus, comprising:
a reception step of receiving integrated version information on a version upgrade program from the distribution server in a case where the version upgrade program for a function module of a type corresponding to the image processing apparatus is present in the distribution server, the integrated version information being used for unifying functions of function modules of image processing apparatuses of different types on the network;
an update step of updating, based on the integrated version information received in said reception step, version upgrade information indicating a version to which the function module of the image processing apparatus can be upgraded;
an acquisition step of acquiring version upgrade information on the function module of at least one other image processing apparatus of different type on the network; and
a determination step of determining, based on the version upgrade information updated in said update step and the version upgrade information acquired in said acquisition step, whether the function module of the image forming apparatus should be version-upgraded.

9. A computer-readable storage medium storing a program for causing a computer to execute a control method for an image processing apparatus connected via a network to a distribution server for at least distributing a program for the image processing apparatus, the control method comprising:
a reception step of receiving integrated version information on a version upgrade program from the distribution server in a case where the version upgrade program for a function module of a type corresponding to the image processing apparatus is present in the distribution server, the integrated version information being used for unifying functions of function modules of image processing apparatuses of different types on the network;
an update step of updating, based on the integrated version information received in said reception step, version upgrade information indicating a version to which the function module of the image processing apparatus can be upgraded;
an acquisition step of acquiring version upgrade information on the function module of at least one other image processing apparatus of different type on the network; and
a determination step of determining, based on the version upgrade information updated in said update step and the version upgrade information acquired in said acquisition step, whether the function module of the image forming apparatus should be version-upgraded.
